(19) United States
(12) Patent Application Publication
(10) Pub. No.: US 2026/0342806 A1
(43) Pub. Date: Oct. 29, 2026

(54) VALIDATING GEO-LOCATION FOR DATA ACCESS

(71) Applicant: International Business Machines Corporation, Armonk, NY (US)

(72) Inventors: Scott Anthony EXTON, Shailer Park (AU); Paritosh RANJAN, Kolkata (IN)

(21) Appl. No.: 19/191,436

(22) Filed: Apr. 28, 2025

(51) Int. Cl. H04L 9/40; G06F 16/29

(52) U.S. Cl. CPC H04L 63/107; G06F 16/29

(57) ABSTRACT

In some implementations, a client device may request access to a cloud-based application that uses data that is stored in a geographic location. The client device may receive a response from the cloud-based application, the response including a geo-location header that includes a reference to a geo-location authority. The client device may request geo-location information associated with data from the geo-location authority referenced by the geo-location header, the geo-location information indicating a validity state for the data based at least in part on one or more regional regulations associated with the geographic location of the data. The client device may display an indication of the validity state for the data.

### BACKGROUND

This disclosure generally relates to data sovereignty, and more specifically, to validating geo-location for data access.

### SUMMARY

Some aspects described herein relate to a method. The method may include requesting, by a client device, access to a cloud-based application that uses data that is stored in a geographic location. The method may include receiving, by the client device, a response from the cloud-based application, the response including a geo-location header that includes a reference to a geo-location authority. The method may include requesting, by the client device, geo-location information associated with data from the geo-location authority referenced by the geo-location header, the geo-location information indicating a validity state for the data based at least in part on regional regulations associated with a location of the client device. The method may include displaying an indication of the validity state for the data using the geo-location information.

Some aspects described herein relate to a method. The method may include receiving, by a geo-location authority, a registration request to register an application with the geo-location authority. The method may include obtaining, by the geo-location authority and using a cloud environment agent, geo-location information associated with the application, the geo-location information being based at least in part on one or more services that are used by the application and are registered with the cloud environment agent. The method may include storing, by the geo-location authority, the geo-location information in a database, the geo-location information being linked to the application.

Some aspects described herein relate to a computer program product. The computer program product may include one or more computer-readable storage media and program instructions stored on the one or more computer-readable storage media to perform operations. The operations may include requesting access to a cloud-based application that uses data that is stored in a geographic location. The operations may include receiving a response from the cloud-based application, the response including a geo-location header that includes a reference to a geo-location authority. The operations may include requesting geo-location information associated with data from the geo-location authority referenced by the geo-location header, the geo-location information indicating a validity state for the data based at least in part on regional regulations associated with a location of a client device. The operations may include displaying an indication of the validity state for the data.

Some aspects described herein relate to a method. The method may include receiving, by a geo-location authority, a registration request to register an application with the geo-location authority. The method may include obtaining, by the geo-location authority and using a cloud environment agent, geo-location information associated with the application, the geo-location information being based at least in part on one or more services that are used by the application and are registered with the cloud environment agent. The method may include storing, by the geo-location authority, the geo-location information in a database, the geo-location information being linked to the application.

### BRIEF DESCRIPTION OF THE DRAWINGS

FIG. 1 is a diagram of an example computing environment for validating geo-location for data access described herein.

FIG. 2 is a diagram of an example of registering an application with a geo-location authority.

FIG. 3 is a diagram of an example of validating one or more geo-locations associated with an application using a geo-location authority.

FIG. 4 is a diagram of an example of a user interface that displays an indication of a validity state.

FIG. 5 is a flowchart of an example process associated with validating geo-location for data access.

FIG. 6 is a flowchart of an example process associated with validating geo-location for data access.

### DETAILED DESCRIPTION

The following detailed description of example implementations refers to the accompanying drawings. The same reference numbers in different drawings may identify the same or similar elements. “Data sovereignty” denotes a country or jurisdiction having an authority and/or right to govern and control data that is collected or stored within the associated boarders. Alternatively, or additionally, “data sovereignty” denotes that the data is subject to the laws and regulations of the country in which it is collected, processed, or stored. As a result, data sovereignty may include, or be based at least in part on, laws and/or regulations that are specified by a country to protect the data of corresponding citizens and organizations of the country to ensure that the data is not accessed, processed, or stored in unauthorized locations. That is, data sovereignty may ensure that data is stored, processed, and accessed in compliance with local laws and regulations. Enforcing data sovereignty may enable a country to maintain control and oversight over data to mitigate unauthorized access or misuse.

Cloud computing is a model for delivering computing services over the internet, where resources (e.g., servers, storage, databases, software, and/or applications) are provided as a service to users on-demand, allowing for greater flexibility, scalability, and accessibility. The adoption of cloud computing has led to a significant increase in the use of data and services from diverse geographic locations by various computing applications. For instance, a social media application may use cloud computing services to store user data in a data center in the United States, while also leveraging machine learning algorithms hosted in a data center in Ireland and image processing services located in a data center in Singapore.

While cloud computing may provide greater flexibility and scalability of an application and/or services, the increased use of global cloud infrastructure may also increase an amount of data stored and processed across multiple jurisdictions, resulting in challenges in ensuring that data is handled in compliance with the data sovereignty laws and regulations of the country or jurisdiction in which the data is collected, processed, or stored. To illustrate, the distributed infrastructure, dynamic resource allocation, and multi-entity structure of cloud computing may result in a data flow that crosses multiple networks, systems, and geographic boundaries. Alternatively, or additionally, cloud computing may involve navigating multiple potential data pathways, handoffs, and processing points, which may introduce latency, ambiguity, or misattribution of data location. For example, a cloud-based application may use a content delivery network (CDN) that caches data in multiple locations around the world, making determination of an exact location of the data challenging. In some cases, cloud providers may use automated routing and load balancing mechanisms that dynamically redirect data traffic, further complicating the task of determining data location. As a result, the use of cloud computing can significantly increase the complexity of tracking data and service locations. The inability to accurately track and manage the location of data and services used by an application may lead to unauthorized data transfers, non-compliance with data sovereignty operating conditions, and exposure to data breaches. Alternatively, or additionally, failure to ensure compliance with data sovereignty regulations may result in costly data repatriation, business disruptions, and/or a removal of services from non-compliant regions.

Some implementations described herein provide a mechanism for verifying the geographic location of data and services accessed by a computing application. In some aspects, a client device may request access to a cloud-based application. The client device may receive a response to the access request, where the response includes a geo-location header that includes a reference to a geo-location authority. The client device may send a request for geo-location information that is associated with the cloud-based application using the reference to the geo-location authority, such as geo-location information associated with data that is used by the cloud-based application and/or geo-location information that is associated with one or more services used by the cloud-based application. The client may receive the geo-location information and/or may receive an indication of a validity state for the data based on regional regulations associated with the geographic location of the data. In some aspects, the client device may display an indication of the validity state for the data. “Geo-location information” denotes data that includes details about a geographic location associated with a cloud-based service and/or cloud-based data. To illustrate, geo-location information may indicate a geographic location of where cloud-based data is stored, processed, or accessed.

The use of a geo-location authority to manage the registration of cloud-based applications, and geo-location information associated with the cloud-based applications, may mitigate the complexity of tracking data and service locations, unauthorized data transfers, and non-compliance with data residency requirements. To illustrate, the geo-location authority may provide a centralized and trusted source of geo-location information that may be used by a client device to verify the location of data and services used by cloud-based applications. By doing so, the geo-location authority enables a client device to accurately determine the location of data and services, and to ensure that data is handled in compliance with the data sovereignty laws and/or data regulations of the country or jurisdiction in which the data is collected, processed, or stored. Providing accurate location information, and ensuring that data is handled in compliance with the data sovereignty laws, may reduce the risk of data breaches, costly data repatriation, and/or business disruptions associated with non-compliance with data sovereignty regulations.

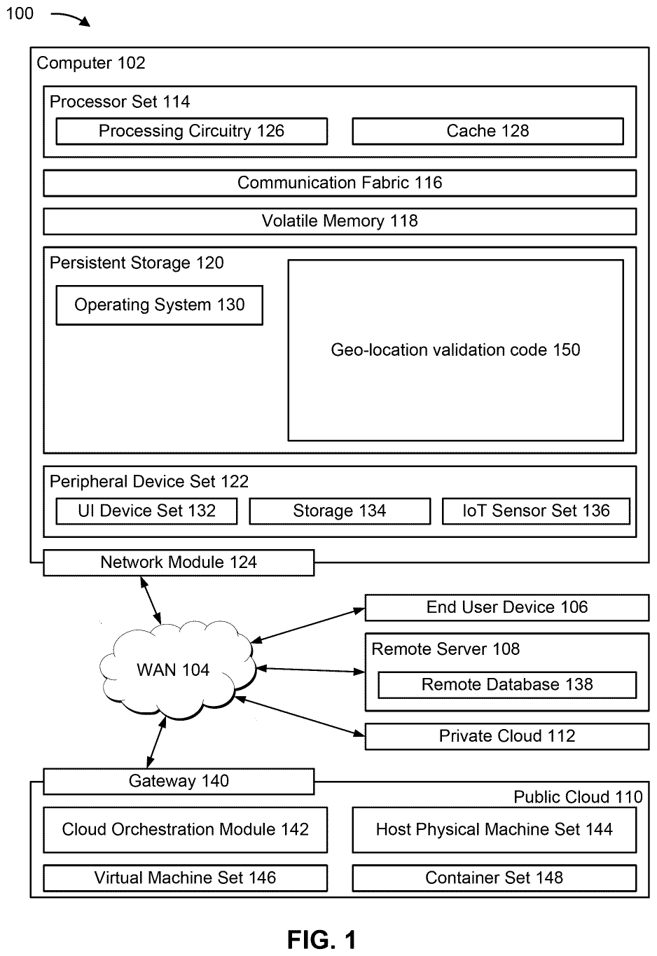

FIG. 1 is a diagram of an example computing environment 100 for validating geo-location for data access described herein.

The computing environment 100 contains an example of an environment for the execution of at least some of the computer code involved in performing the inventive methods, such as geo-location validation code 150. In addition to the geo-location validation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the geo-location validation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

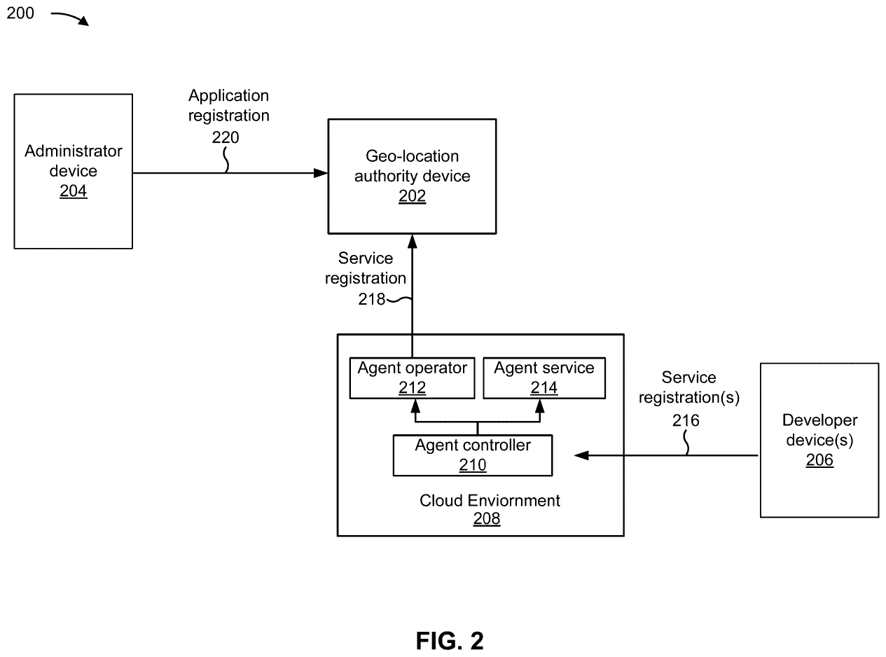

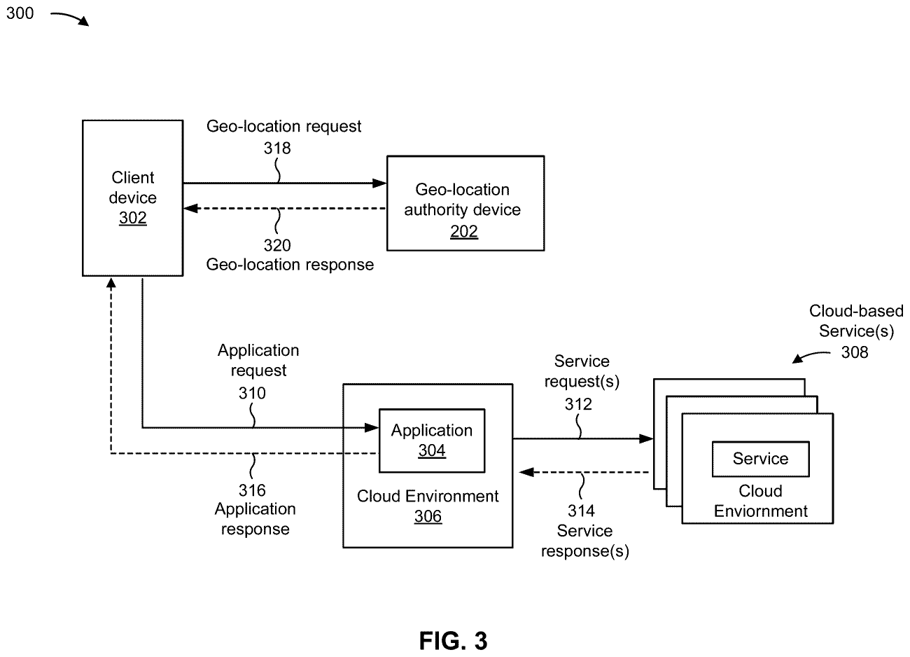

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in geo-location validation code 150 in the persistent storage 120. In some aspects, the geo-location validation code 150 may be stored on a client device (e.g., a first computer 102) as described below with regard to FIG. 2 and may include instructions to enable the client device to perform operations as described herein. Alternatively, or additionally, the geo-location validation code 150 may be stored on a geo-location authority device (e.g., a second computer 102) as described below with regard to FIG. 2 and FIG. 3 and may include instructions to enable the geo-location authority device to perform operations as described herein.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the geo-location validation code 150 typically includes at least some of the computer code involved in performing one or more operations described herein. The operations may include, for example, requesting access to a cloud-based application that uses data that is stored in a geographic location; receiving a response from the cloud-based application, the response including a geo-location header that includes a reference to a geo-location authority; requesting geo-location information associated with data from the geo-location authority referenced by the geo-location header, the geo-location information indicating a validity state for the data based at least in part on one or more regional regulations associated with the geographic location of the data; and displaying an indication of the validity state for the data.

In some implementations, the operations may include receiving a registration request to register an application with the geo-location authority; obtaining, using a cloud environment agent, geo-location information associated with the application, the geo-location information being based at least in part on one or more services that are used by the application and are registered with the cloud environment agent; and storing the geo-location information in a database, the geo-location information being linked to the application. “Cloud environment agent” denotes a software component that manages and orchestrates the deployment and operation of any combination of one or more applications and/or one or more services within a cloud environment.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

FIG. 2 is a diagram of an example 200 of registering an application with a geo-location authority. The example 200 includes a geo-location authority device 202, an administrator device 204, a developer device 206, and a cloud environment 208.

The geo-location authority device 202 may be one or more computing devices that provide a centralized entity (e.g., a geo-location authority) that manages and provides geo-location information for applications and services. “Centralized entity” denotes a single, unified system or organization that manages and maintains any combination of a particular function, process, and/or dataset in a consolidated and coordinated manner, such as by aggregating data from multiple sources, eliminating redundancies, and providing a single, unified view of the data. A centralized entity may be implemented in a variety of ways, such as by using a single computer or server, a distributed system with multiple nodes, a cloud-based infrastructure, and/or a hybrid model that combines on-premises and cloud-based components. Accordingly, while FIG. 2 illustrates the geo-location authority device 202 as a single device for clarity, other examples may include a cluster of servers, a cloud-based service, or a distributed system with multiple nodes, such as a blockchain-based system. Based at least in part on operating as a centralized entity, the geo-location authority device 202 may provide a single point of control (e.g., a single interface) and/or management for geo-location validation. Using a single point of control may reduce a complexity and administrative burden associated with managing multiple sources of geo-location data and/or may enable an application and/or service to use a single, trusted source of geo-location information. To illustrate, the geo-location authority device 202 may maintain a unified database of any combination of one or more applications and/or one or more services that are registered with the geo-location authority device. Alternatively, or additionally, the geo-location authority device 202 may autonomously aggregate and maintain a comprehensive repository of geo-location information on behalf of registered entities, such as by using a centralized database that stores and correlates geo-location information for each registered application and/or service. Using the geo-location authority device 202 as a centralized entity may result in simplified management, improved accuracy, and/or enhanced security of geo-location information in order to ensure compliance with data sovereignty laws and regulations.

The administrator device 204 may be one or more computing devices that enable administrators to interface with the geo-location authority device 202. In some aspects, the administrator device 204 may be used by a user (e.g., an administrator) to register an application and/or service with a geo-location authority that is provided based at least in part on the geo-location authority device 202. As an example, the administrator device 204 may provide any combination of a web-based interface, a command-line interface, or a graphical user interface that enables a user to provide input that results in the administrator device 204 communicating with the geo-location authority device 202 via a connection established over a network, such as a LAN, a WAN, or the Internet. The administrator device 204 and the geo-location authority device 202 may communicate using any combination of standardized messaging protocols, such as hypertext transfer protocol (HTTP), Extensible Markup Language (XML)-based protocols, Simple Object Access Protocol (SOAP), and/or Representational State of Resource (REST)-based protocols, which may be secured using Transport Layer Security (TLS) or Secure Sockets Layer (SSL) encryption.

The developer device 206 may be one or more computing devices that enable developers to design, develop, and deploy one or more applications and/or services, such as cloud-based applications that may access data and/or services from various geographic locations. In some aspects, the developer device 206 may communicate with a controller of a cloud environment agent, such as a cloud environment agent located in the cloud environment 208, to deploy and manage applications and services in the cloud environment 208. For example, the developer device 206 may communicate with one or more components of the cloud environment agent using standardized messaging protocols, such as HTTP, XML-based protocols, or REST-based protocols, to deploy a Kubernetes-based application in the cloud environment 208 as described below. Example components of the cloud environment agent may include an agent controller 210, an agent operator 212, and/or an agent service 214.

The cloud environment 208 may be a distributed infrastructure that hosts applications and/or services, and may be responsible for providing the necessary resources and scalability for these applications. In some aspects, the cloud environment 208 may be implemented as a public cloud, private cloud, or hybrid cloud, using cloud computing platforms (e.g., International Business Machines (IBM) Cloud, Amazon Web Services (AWS), Microsoft Azure, and/or Google Cloud Platform (GCP)). The cloud environment 208 may include, for example, a computer 102 that provides processing and storage resources, a WAN 104 that connects the computer 102 to other components and systems, an EUD 106 that accesses applications and services hosted in the cloud environment 208, a remote server 108 that provides data storage and retrieval services, a public cloud 110 that provides scalable and on-demand computing resources, and a private cloud 112 that provides secure and isolated computing resources, as well as other components and systems that enable the deployment and management of applications and services in a cloud-based infrastructure. Within the cloud environment 208, a cloud environment agent, such as a Kubernetes cloud environment agent, may be implemented to manage and orchestrate the deployment and operation of applications and services.

The cloud environment agent may include an agent controller 210 that may manage the overall operation of the cloud environment agent and/or may coordinate the deployment and registration of services in the cloud environment 208. For example, the agent controller 210 may be implemented as a controller (e.g., a Kubernetes controller) that uses a container orchestration system (e.g., a Kubernetes control plane) to manage the deployment and scaling of applications and services in the cloud environment 208. The cloud environment agent may also include an agent operator 212 that automates specific tasks or operations within the cloud environment 208, such as the registration of services with a geo-location authority device 202. For example, the agent operator 212 may be implemented as a Kubernetes operator that uses custom resources to automate the registration of services with the geo-location authority device 202. Additionally, the cloud environment agent may include an agent service 214 that provides specific functionality or services to applications and services deployed in the cloud environment 208. For example, the agent service 214 may be implemented as a Kubernetes service that provides a network identity and load balancing for applications and services deployed in the cloud environment 208.

To illustrate, as shown by reference number 216, developer device(s) 206 may register one or more services with the cloud environment agent based at least in part on communicating with the agent controller 210 (e.g., a Kubernetes control plane). The registration process may include the developer device(s) 206 sending a service registration request to the agent controller 210, and the agent controller processing the request, such as by updating a database and/or service registry of the cloud application agent to include the service. For example, the service registration request may include information about the service, such as a service identifier, a service description, and/or location information (e.g., a set of latitude and longitude coordinates) that identifies a geographic location of the service. Alternatively, or additionally, the agent controller 210 may use various methods to obtain geo-location information for the services being registered, such as by querying a geo-location database, using a geolocation application programming interface (API), or retrieving location information from a global positioning system (GPS) device or a cellular network. For instance, the agent controller 210 may use the agent operator 212 (e.g., a Kubernetes operator) to retrieve location information from a pod or a container that is hosting the service. In some cases, the agent controller 210 may receive location information from a third-party service, such as a geo-location service that provides location data based on Internet protocol (IP) addresses or domain name system (DNS) names.

As part of the registration process, the agent controller 210 may validate the service information and ensure that it is accurate and complete. For example, the agent controller 210 may verify that the service identifier is unique and that the service description conforms to a specific format or standard. Based at least in part on the registration request being valid, the agent controller 210 may update the service registry with the new service information, which may include the geo-location information associated with the services. In some cases, the registration process may include the agent controller 210 sending a confirmation message to the developer device(s) 206, indicating that the service has been successfully registered. The confirmation message may include information such as a unique identifier for the registered service, which may be used to identify the service and its associated geo-location information.

Alternatively, or additionally, as shown by reference number 218, the agent operator 212 may register the service(s) (e.g., from the developer device(s) 206) with the geo-location authority device 202. As one example, the agent operator 212 may send a service registration request to the geo-location authority device 202 using standardized messaging protocols (e.g., HTTP or XML-based protocols), such as by sending a HTTP POST request, where POST is a label that identifies a method for sending data to a server for processing and storing. The service registration request may include a payload that carries service information (e.g., service metadata), examples of which include any combination of a service identifier, a service description, and/or geo-location information. In some cases, the agent operator 212 may provide additional information, such as a service level agreement (SLA) or a quality of service (QoS) policy, as part of the service registration request.

The geo-location authority device 202 may use the information from the agent operator 212 to manage and enforce service level agreements and quality of service policies for the registered services. For example, the geo-location authority device 202 may process the service registration request by updating a database and/or a service registry associated with the geo-location authority device 202, to include the registered service and the corresponding service information (e.g., a service description, and/or geo-location information). To illustrate, the geo-location authority device 202 may use a database management system, such as a relational database or a non-relational database (e.g., a not only structured query language (NoSQL) database), to store and manage the service registry, and the agent operator 212 may use a data access protocol, such as a RESTful API, to interact with the database and register the service. In some aspects, the geo-location authority device 202 may perform validation and verification checks on the service registration request, such as searching for duplicate service identifiers or invalid geo-location information, before updating the service registry. As one non-limiting example, the geo-location authority device 202 may use a hash table or an indexing mechanism to search for duplicate service identifiers, and may use a set of predefined rules or algorithms to validate the geo-location information. As another example, the geo-location authority device 202 may use a caching mechanism to store previously validated service identifiers and geo-location information, to reduce an amount of time to perform the validation and verification process.

As shown by reference number 220, the administrator device 204 may register an application with the geo-location authority device 202. For example, the administrator device 204 may communicate with the geo-location authority device 202 using standardized messaging protocols (e.g., HTTP or XML-based protocols), such as by sending a HTTP POST request, that includes a payload that carries application information (e.g., application metadata), such as an application identifier, an application description, and/or service information (e.g., one or more identifiers of services used by the application). To illustrate, the administrator device 204 may provide a list of services (e.g., one or more of the services described with regard to reference number 216) used by the application.

The geo-location authority device 202 may process the request and update a database used by the geo-location authority device 202, such as by adding a new entry for the registered application or updating an existing entry with new information. In some cases, the geo-location authority device 202 may store the application with the corresponding service(s) in the database. Alternatively, or additionally, the application registration request may include a unique identifier (ID) for the application, such as an application ID or a namespace, and the unique ID may be used to identify the application and associated geo-location information. For example, the application registration request may include a namespace, such as “my-namespace”, which may be used to identify the application and the associated services (e.g., in a database). The geo-location authority device 202 may use the unique ID to correlate the application with one or more services used by the application, such as by storing the unique ID in a database entry that is associated with the application and/or the one or more services. By associating the application with the registered service(s), the geo-location authority device 202 may provide accurate and authoritative geo-location information that enables the application to use location-based services and features, as described below with regard to FIG. 3.

FIG. 2 is provided as an example. Other examples may differ from what is described with regard to FIG. 2.

FIG. 3 is a diagram of an example 300 of validating one or more geo-locations associated with an application using a geo-location authority. The example 300 includes the geo-location authority device 202 described with regard to FIG. 2, a client device 302, and an application 304 that may be a cloud-based application that uses a cloud environment 306 and/or one or more cloud-based services 308.

The client device 302 may be a computing device, such as a desktop computer 102, laptop computer, tablet computer, smart phone, or other device with a capability to access the application 304. To illustrate, the client device 302 may access the application 304 through various interfaces, such as a web browser, a mobile app, a command-line interface, or an API interface. Alternatively, or additionally, the client device 302 may access the application 304 using a command-line interface, such as a terminal or a command prompt, or through an API interface, such as one or more APIs that enable interacting with and retrieving data from web services (e.g., a RESTful API). As one example, the client device 302 may have a connection to the cloud environment 306 via a LAN, a WAN, a wireless local area network (WLAN), or other network connection, and may use various standardized communication protocols, such as HTTP, hypertext transfer protocol secure (HTTPS), or file transfer protocol (FTP), to access the application 304.

In a similar manner as described with regard to FIG. 2, the application 304 may be registered with the geo-location authority device 202. As described above, the application 304 may be a cloud-based application, such as a SaaS application, a platform-as-a-service (PaaS) application, or an infrastructure-as-a-service (IaaS) application. As a cloud-based application, the application 304 may provide a variety of functions, such as data storage, data processing, or data analysis, that may be based at least in part on one or more services (e.g., the cloud-based services 308). For example, the application 304 may use a first cloud-based storage service to store and retrieve data, a second cloud-based computing service to process and analyze data, and/or a third cloud-based database service to manage and query data.

In the example 300, the application 304 resides in the cloud environment 306 such that the application 304 is a cloud-hosted application, rather than being installed and run locally on the client device 302. In such a scenario, all or a majority of the functionality of the application 304 may be executed on servers or instances within the cloud environment 306. To illustrate, the client device 302 may access the application 304 using a web browser to send and receive messages from the application 304, and processing tasks may be performed on the servers or instances within the cloud environment 306. In other examples, at least a portion of functionality provided by the application 304 may be deployed on the client device 302, such as a thin client or a mobile app that provides a user interface to the cloud-based application. In such a scenario, the client device 302 may provide some processing power or storage for the application 304, and at least some functionality of the application 304 may be provided by the cloud-based services 308. Accordingly, the application 304 may be a distributed application that has functionality residing on both the client device 302 and the cloud environment 306.

The cloud environment 306 may be implemented in a similar manner as described with regard to the cloud environment 208 described with regard to FIG. 2. The cloud environment 306 may include one or more cloud-based services, such as data storage services, data processing services, or data analysis services, that may be hosted on one or more servers or instances within the cloud environment 306. In some examples, the cloud environment 306 may include the cloud-based services 308. Accordingly, although the example 300 shows the cloud-based services 308 in a separate cloud environment for clarity, the cloud-based services 308 may be part of the same cloud environment 306 as the application 304. In either case, the cloud-based services 308 may be provided by a cloud service provider and/or may be executed and stored on servers or instances located in one or more geographic locations.

As shown by FIG. 3, the client device 302 may send an application request 310 to the application 304. For example, the client device 302 may access the application 304 using a web browser, a network module 124 as described with regard to FIG. 1, and a connection to the cloud environment 306, as described above. Other examples may include the client device 302 sending the application request 310 using a mobile app, a command-line interface, a RESTful API, or a messaging protocol, such as HTTP, HTTPS, or WebSocket. In some aspects, the client device 302 may send the application request 310 using a thin client or a virtual private network (VPN) connection to the cloud environment 306. The application request 310 may be transmitted using a variety of protocols, such as HTTP, HTTPS, Mobile Device Management (MDM), Wireless Application Protocol (WAP), Remote Desktop Protocol (RDP), Virtual Network Computing (VNC) protocol, or Citrix Independent Computing Architecture (ICA) protocol, and the connection to the cloud environment.

The application request 310 may include a variety of information, such as user credentials (e.g., username and password), application data (e.g., user input, file uploads), or other information (e.g., device location, device type), that may be used by the application 304 to process the request. To illustrate, the application request 310 may include a user identifier, a session token, or an authentication token, and the application 304 may use the user identifier, the session token, or the authentication token to authenticate and authorize the request. The application request 310 may also include data related to the requested service, such as a file to be stored, a message to be sent, or a query to be executed.

In some examples, the application request 310 may include geo-location information, such as a set of coordinates (e.g., latitude and longitude) or a geographic location (e.g., city, state, country), which the application 304 may use to provide location-based services or to determine the validity of the request. The application request 310 may also include other types of information, such as a timestamp, a device identifier, or a browser type, which the application 304 may use to process the request or to provide personalized service.

As shown by FIG. 3, the application 304 may send a service request 312 to the cloud-based services 308. The service request 312 may include a variety of information, such as application data (e.g., user input, file uploads), user data (e.g., user credentials, personalized settings), or other information (e.g., device location, device type) that may be used by the cloud-based services 308 to process the request. For example, the application 304 may send a service request 312 to a cloud-based storage service to retrieve stored files associated with the client device, and the service request 312 may include the user credentials and a query to identify the files to be retrieved.

In some examples, the service request 312 may include geo-location information, such as a set of coordinates (e.g., latitude and longitude) or a geographic location (e.g., city, state, country), which the cloud-based services 308 may use to provide location-based services or to determine the validity of the request. For instance, the application 304 may send a service request 312 to a cloud-based mapping service to retrieve a map of the user's current location, and the service request 312 may include the user's current geo-location coordinates.

As shown by FIG. 3, the cloud-based service(s) 308 may process the service request 312 and return one or more service response(s) 314, and a service response may include a variety of information, such as processed data, analysis results, or other information. As one example, the cloud-based services 308 may respond to the service request 312 by sending a processed data file, such as an image or a document, or by sending an analysis result, such as a summary of one or more stored files. In some cases, the cloud-based services 308 may use the geo-location information included in the service request 312 to modify the response. For instance, a cloud-based mapping service may provide turn-by-turn directions to a location that is indicated by the geo-location information.

The application 304 may send, and the client device 302 may receive, an application response 316. The application response 316 may include the processed data, analysis results, or other information received from the cloud-based services 308, as well as any additional information, such as application data or user data. In some cases, the application response 316 may include a geo-location header, which provides information about the geographic location of the cloud-based services 308 used by the application 304. To illustrate, the geo-location header may include a reference to the geo-location authority device 202, such as by including a uniform resource identifier (URI) associated with the geo-location authority device 202, a uniform resource locator (URL) associated with the geo-location authority, and/or a unique token associated with the geo-location authority. In another example, the geo-location header may include a unique identifier or token that is associated with the geo-location authority device 202, such as “Geo-Location-Authority-ID: 123456789”.

Based at least in part on receiving the application response 316, the client device may send, and the geo-location authority device 202 may receive, a geo-location request 318. The client device may send the geo-location request 318 using a variety of protocols, examples of which are provided above. In some examples, the geo-location request 318 may be sent by a browser plugin or extension that is installed on the client device 302. A browser plugin or extension is a software component that may be installed on a web browser and integrates with the browser functionality to provide additional features or services. As an example, a plugin or extension may intercept and process web traffic, modify web page content, or interact with external systems. To illustrate, a browser plugin or extension may generate a geo-location request 318 by intercepting and extracting a geo-location header from an application response 316, parsing the geo-location header to obtain a geo-location authority identifier, and constructing a request to the geo-location authority device 202. As an example of constructing a request, the browser plugin or extension may use a RESTful API or an HTTP request.

In another example, the client device 302 may generate and send the geo-location request 318 using a scripting language, such as JavaScript, that is executed by a web browser or a runtime environment on the client device 302. For instance, the scripting language may use a library or framework, such as a standardized API for sending and receiving data or a web API that provides a method for fetching resources, to send a request to the geo-location authority device 202. In yet another example, the client device 302 may generate and send the geo-location request 318 using a mobile application or a thin client installed on the client device 302. For instance, the mobile application or thin client may use a networking library or framework, such as an HTTP client library, to send a request to the geo-location authority device 202. In some cases, the geo-location request 318 may indicate a request for geo-location information associated with data or services used by the application 304.

The geo-location request 318 may include information that identifies data and/or one or more services associated with a request for geo-location information. For example, the geo-location request 318 may include a unique identifier or token that is associated with the application 304, such as an application ID or a namespace. Alternatively, or additionally, the geo-location request 318 may include user credentials or authentication tokens that enable the geo-location authority device 202 to authenticate and authorize the request. Example user credentials or authentication tokens may include a username and password, or a token that was previously issued by the geo-location authority device 202. In some cases, the geo-location request 318 may be cached by the client device 302, or by an intermediate caching layer to reduce a messaging latency. For example, the client device 302 may cache the geo-location request 318 and re-use the cached geo-location request for subsequent requests, or an intermediate caching layer may cache the geo-location request 318 and re-use it for multiple client devices 302.

Based at least in part on receiving the geo-location request 318, the geo-location authority device 202 may retrieve and process the geo-location information for the data or services used by the application 304. In some cases, the geo-location authority device 202 may use the geo-location information to determine whether the cloud-based services 308 used by the application 304 are located in a valid geographic location. In other cases, the geo-location authority device 202 may return the geo-location information to enable the client device 302 to perform a validation process.

To illustrate, the geo-location authority device 202 may use information from the geo-location request 318, such as a unique identifier for the application 304, a service identifier, or a geo-location code, to retrieve geo-location information from a database used by the geo-location authority device 202. “Geo-location code” denotes a code (sometimes a standardized format) that specifies the geographic location, examples of which are provided below. In some aspects, the geo-location authority device 202 may submit a database query that includes a unique ID for the application 304, such as an application ID or a namespace, or other identifying information. For example, the geo-location authority device 202 may use a structured query language (SQL) query or a NoSQL query to retrieve the geo-location information from a relational database or a non-relational database, respectively.

In some cases, the geo-location authority device 202 may use the retrieved geo-location information to determine whether the cloud-based services 308 used by the application 304 are located in a valid geographic location. For instance, the geo-location authority device 202 may compare the geo-location information to a set of predefined rules or policies that specify the valid geographic locations for data or services, such as by verifying whether the cloud-based services 308 are located within a specific country, region, or city, or whether the cloud-based services 308 are located outside of a specific country, region, or city. The set of predefined rules or policies that specify the valid geographic locations for data or services may be defined by the geo-location authority device 202, or may be obtained from an external source, such as a regulatory body, an industry organization, or a third-party data provider. For example, the geo-location authority device 202 may use a database or a configuration file to store the predefined rules or policies. The predefined rules or policies may be updated periodically to reflect changes in regulatory requirements or industry standards. Alternatively, the geo-location authority device 202 may retrieve the predefined rules or policies from a remote server or a cloud-based service that provides access to a centralized repository of regulatory requirements and industry standards. In some cases, the predefined rules or policies may be based on user input or configuration settings (e.g., at the geo-location authority device 202), which may be provided through a user interface or an API. For example, an administrator may use a web-based interface to configure the predefined rules or policies for a specific organization or industry, based on their unique regulatory requirements or business needs.

The geo-location authority device 202 may use the retrieved geo-location information to validate the location of the data or services against a set of regulatory requirements or compliance standards. For instance, the geo-location authority device 202 may check whether the cloud-based services 308 are compliant with data sovereignty regulations, such as the General Data Protection Regulation (GDPR) in the European Union, or the Health Insurance Portability and Accountability Act (HIPAA) in the United States. In some cases, the geo-location authority device 202 may use the retrieved geo-location information to validate the location of the data or services against a set of industry-specific standards or best practices.

Based at least in part on retrieving the geo-location information and/or validating the geo-location information, the geo-location authority device may generate and send a geo-location response 320. In some cases, the geo-location response 320 may include a validation result, such as through the use of any combination of a binary value (e.g., valid or invalid), a text string (e.g., “valid” or “invalid”), or a numeric code (e.g., 0 or 1).

Alternatively, or additionally, the geo-location response 320 may include one or more geo-location codes that specify the geographic location(s) of the cloud-based services 308 used by the application 304. To illustrate, a geo-location code may specify a country location, a region location, or city location of the cloud-based services 308. The geo-location code may use a standardized format, such as an International Organization for Standardization (ISO) 3166-1 alpha-2 code, an ISO 3166-1 alpha-3 code, or another standardized format. The geo-location code may be represented in a standardized format, such as a two-letter country code (e.g., “AU” for Australia) or a three-letter country code (e.g., “USA” for the United States) as defined by the International Organization for Standardization (ISO) 3166-1 standard. Other examples of standardized geo-location codes include International Air Transport Association (IATA) airport codes (e.g., “SYD” for Sydney Airport in Australia or “SEA” for Seattle-Tacoma International Airport in the United States) and GeoNames (e.g., a unique identifier for a specific geographic location, such as a city or town in Australia). Using standardized codes may provide a consistent and reliable way to identify and reference geographic locations. Alternatively, or additionally, the geo-location response 320 may include validation information that may be used by the client device 302 to verify the accuracy and freshness of the geo-location information, such as a timestamp or a version number.

The geo-location authority device 202 may send the geo-location response 320 using a network, such as the internet or a WLAN as described above. In some cases, the geo-location response 320 may be sent directly to the client device 302 or may be routed through one or more intermediate nodes or servers. Alternatively, the geo-location authority device 202 may use a messaging service or application programming interface (API) to send the geo-location response 320 to the client device 302.

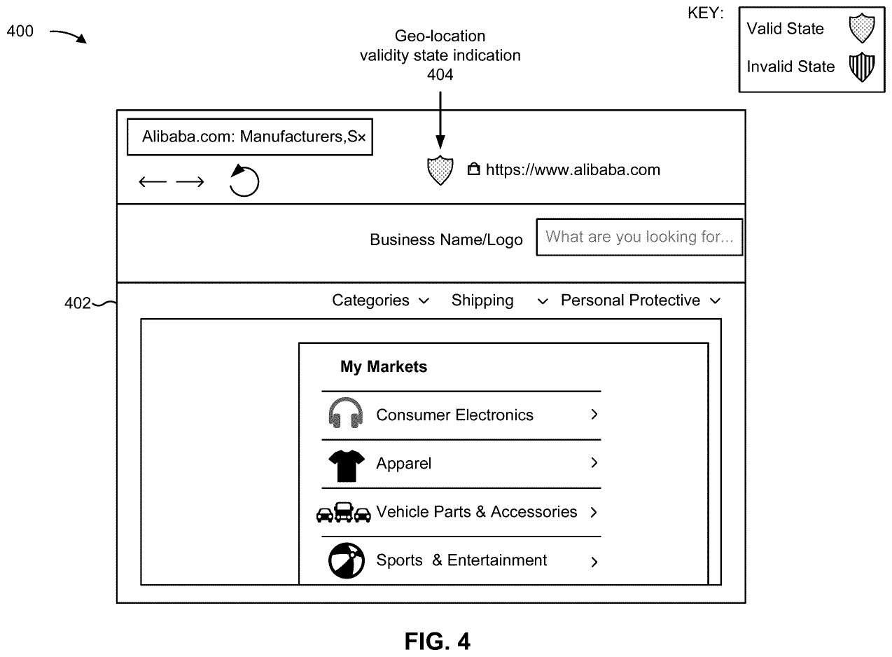

In some aspects, the client device 302 may display an indication of validity state of the geographic location of the cloud-based services 308 used by the application 304, such as by displaying an icon as described below with regard to FIG. 4. The client device 302 may display the indication of the validity state using a variety of methods, such as by displaying any combination of a graphical icon, a text message, or a warning message that indicates the validity state. As one example, a browser plugin at the client device 302 may intercept and process the geo-location response 320 from the geo-location authority device 202 to determine the validity state of the geographic location of the data or services accessed by the application. Alternatively, or additionally, the browser plugin may display an indication of the validity state, such as an icon or text message, directly within the browser interface.

The client device 302 may use the geo-location response 320 to determine the validity state of the geographic location of the cloud-based services 308 used by the application 304. As one example, the client device 302 may retrieve a validity result from the geo-location response 320, where the validity result is a binary value (e.g., valid or invalid), a text string (e.g., “valid” or “invalid”), or a numeric code (e.g., 0 or 1) that indicates whether the geographic location of the cloud-based services 308 is compliant with the data sovereignty regulations or policies of the region. As another example, the client device 302 may derive or compute the validity state by comparing the geo-location information received in the geo-location response 320 with a set of predefined rules or policies that specify the valid geographic locations for data or services and/or a list of approved countries or regions (e.g., indicated by commensurate geo-location code format) that are stored locally on the client device 302 or retrieved by the client device 302 from a remote server. Based at least in part on the received geo-location code matching an approved geo-location code, the client device 302 may determine that the validity state is valid. Based at least in part on the received geo-location code not matching an approved geo-location code, the client device 302 may determine that the validity state is invalid.

Any combination of predefined rules, policies, and/or a list of approved countries or regions may be obtained through various means, such as pre-configured settings stored on the client device 302, lists retrieved from a remote server, user input, or an automated update. For example, preconfigured settings may include a default list of approved countries or regions (e.g., using geo-location codes) that are stored at or by the client device 302 during the initial setup or installation process. The client device 302 may update the preconfigured settings iteratively, periodically, or on-demand (e.g., from user input or detecting an update trigger event) by retrieving new lists from a remote server. In some cases, lists retrieved from a remote server may be obtained through a secure connection, such as HTTPS, and/or may be updated at regular intervals (e.g., daily, weekly, monthly) or in response to changes in data sovereignty regulations or policies. User input may include the client device receiving user input that enters a geo-location code or selects one or more approved countries or regions through a user interface on the client device 302. An automated update may include a remote server pushing an updated list to the client device 302, such as a periodic update or an update in response to changes in data sovereignty regulations or policies. The updates may be pushed to the client device 302 through a notification service or pulled by the client device 302 through a periodic query.

Alternatively, or additionally, the client device 302 may use other information received in the geo-location response 320, such as a timestamp or a version number, to determine the validity state. For example, the client device 302 may validate whether the timestamp of the geo-location information is within a time window or whether the version number of the geo-location information is current. Based at least in part on the timestamp being within the time window or the version number being current, the client device 302 may determine that the validity state is valid. Based at least in part on the timestamp not being within the time window or the version number not being current, the client device 302 may determine that the validity state is invalid.

The client device 302 may perform a hybrid of these methods to determine the validity state. For example, the client device 302 may retrieve a validity result from the geo-location response 320 and may perform a comparison of the geo-location information with predefined rules or policies to confirm the validity result.

The client device 302 may display an indication of the validity state of the geographic location of the cloud-based services 308 used by the application 304. The indication may take various forms, such as a graphical icon, a text message, or a warning message. For example, the client device 302 may display an icon on a user interface, such as a shield icon or a padlock icon next to a URL in a browser window. The client device 302 may display the icon as a green icon based at least in part on the validity state indicating that the cloud-based services 308 are located in a valid geographic location, and may display the icon as a red icon for an invalid state. As another example, the client device 302 may display (e.g., on the user interface) a text message (e.g., “Valid” or “Invalid”).

Other examples may include the client device 302 displaying a popup or tooltip in response to receiving user input associated with providing more input. Example user input may include user input associated with a mouse icon hovering over or clicking the indication of the validity state (e.g., an icon). Based at least in part on receiving the user input, the client device 302 may display additional information, such as a country code or a region code associated with the validity state. Accordingly, the client device 302 may provide a mechanism to receive user input associated with retrieving and/or displaying additional information, such as a button or link that the user can click to retrieve more detailed information about the geographic location of the cloud-based services 308. In some cases, the client device 302 may display a user-configurable list of acceptable countries or regions on the user interface that enables a user to select trusted countries or trusted regions.

In some aspects, the client device 302 may receive a notification of a location change for one or more cloud-based services 308 used by the application 304. The notification may include an updated geo-location code that indicates the new geographic location of the cloud-based services 308. Based at least in part on receiving the notification, the client device 302 may update the validity state of the geographic location of the cloud-based services 308 using the updated geo-location code. Alternatively, or additionally, the client device 302 may update a displayed icon, such as by displaying the icon using color (e.g., a yellow icon) associated with an update to a geo-location or by displaying a message, such as “Location updated”, to inform the user of the change. In some aspects, the client device 302 may store a history of geo-location information, and may use the history to track changes in the geographic location of the cloud-based services 308. The client device 302 may display a log or a record of the changes (e.g., in response to receiving user input), and/or may use the log or record to analyze the behavior of the cloud-based services 308.

As described above, a client device (e.g., the client device 302), a geo-location authority device (e.g., the geo-location authority device 202), and a cloud-based application (e.g., the cloud-based application 304) may communicate with one another to validate geo-location information that is associated with a cloud-based service and/or cloud-based data in real-time, where the validation may be based at least in part on data sovereignty rules. To illustrate, the client device may request access to the cloud-based application, and the cloud-based application may send a response that includes a geo-location header. In some aspects, the geo-location header may include a reference to the geo-location authority device (e.g., a URI or a URL). The client device may generate a geo-location request using information from the geo-location header, and may send the geo-location request to the geo-location authority device. Based at least in part on receiving the geo-location request, the geo-location authority may authenticate the client device and/or may retrieve relevant geo-location information (e.g., from a database used by the geo-location authority device). The geo-location authority device may generate a geo-location response that includes the geo-location information and/or validation results generated by the geo-location authority. Based at least in part on receiving the geo-location response from the geo-location authority, the client device may display an indication of a validity state.

Using a real-time validation and feedback mechanism ensures that data sovereignty regulations are adhered to, thereby mitigating the risk of unauthorized data access and non-compliance. That is, by using a geo-location authority to validate the geographic location of cloud-based services used by a cloud-based application, a client device may obtain a validity state of the cloud-based services and indicate the validity state in a clear and concise manner. Indicating a validity state may enable users to make informed decisions about data or service usage and may ensure compliance with data sovereignty regulations or policies. The indication of the validity state may also notify a user of potential unauthorized access and mitigate the exposure of sensitive data, thereby reducing the risk of data breaches.

The use of a geo-location authority provides a trusted and authoritative source of geo-location information about cloud-based services, mitigating the complexity of tracking a geographic location of data and services. For example, the geo-location authority may leverage the information provided at registration to a cloud agent (e.g., Kubernetes) to provide a centralized and trusted source of geo-location information. This reduces the risk of non-compliance with data sovereignty regulations or policies and ensures that sensitive data is protected.

FIG. 3 is provided as an example. Other examples may differ from what is described with regard to FIG. 3.

FIG. 4 is a diagram of an example 400 of a user interface 402 that displays an indication of a validity state.

The user interface 402 is an example of a user interface that may be displayed by a client device, such as the client device 302 described with regard to FIG. 3. The user interface 402 may be a web browser interface, a mobile application interface, or any other type of interface that displays the indication of the validity state. For instance, in the example 400, the user interface 402 is a browser window, but other examples may include a user interface of a mobile application or a thin client interface.

In the example 400, the indication of the validity state is displayed by the client device as an icon 404. The client device may alter the appearance of the icon to indicate the validity state. For example, the icon 404 may use a first color or pattern to indicate a valid state, and a second color or pattern to indicate an invalid state. A third color may be used to indicate a location change. Other examples of indications of the validity state may include a text message, such as “Valid” or “Invalid”, a warning message, or a popup or tooltip that provides additional information about the validity state.

In some aspects, the user interface 402 may provide a mechanism to display additional information associated with the validity state. For example, the user interface 402 may include a user input mechanism, such as a button, link, or dropdown menu, that allows the user to request additional information about the validity state. Examples of user input mechanisms may include a selectable button that the user can click to retrieve additional information about the validity state, a selectable link that the user can click to view more detailed information about the geographic location of the cloud-based services, a dropdown menu that enables the user to select a variety of options and/or information to display, and/or a hover-over text or tooltip that provides additional information about the validity state when the user hovers over the icon 404

In response to receiving the user input, the user interface 402 may display a list of approved countries or regions, and may also display additional information related to the geographic location of the cloud-based services, such as a country code or a region code. For example, the user interface 402 may display a popup window or a tooltip that lists the approved countries or regions, along with their corresponding country codes or region codes, enabling a user to view more detailed information about the validity state and make informed decisions about data or service usage.

FIG. 4 is provided as an example. Other examples may differ from what is described with regard to FIG. 4.

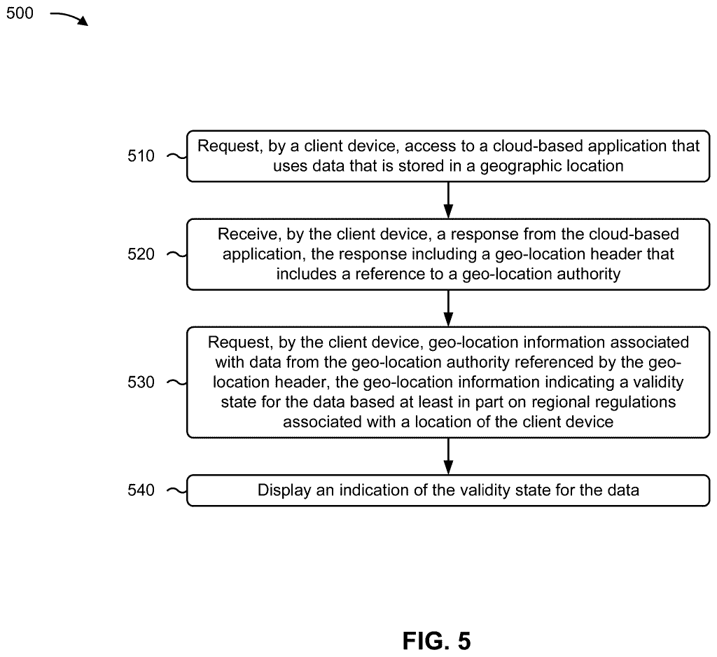

FIG. 5 is a flowchart of an example process 500 associated with validating geo-location for data access. One or more process blocks of FIG. 5 are performed by a client device (e.g., client device 302) and/or by another device or a group of devices separate from or including the client device, such as a geo-location authority device (e.g., geo-location authority device 202), a developer device (e.g., a developer device 206), a cloud environment (e.g., the cloud environment 208 and/or the cloud environment 306) and/or an administrator device (e.g., administrator device 204. Additionally, or alternatively, one or more process blocks of FIG. 5 may be performed by one or more components of computer 102, such as processor set 114, memory 118, persistent storage 120, and/or peripheral device set 122.

As shown in FIG. 5, process 500 includes requesting access to a cloud-based application that uses data that is stored in a geographic location (block 510). For example, the client device may request access to a cloud-based application that uses data that is stored in a geographic location, as described above.

As further shown in FIG. 5, process 500 includes receiving a response from the cloud-based application, the response including a geo-location header that includes a reference to a geo-location authority (block 520). For example, the client device may receive a response from the cloud-based application, the response including a geo-location header that includes a reference to a geo-location authority, as described above.

As further shown in FIG. 5, process 500 includes requesting geo-location information associated with data from the geo-location authority referenced by the geo-location header, the geo-location information indicating a validity state for the data based at least in part on one or more regional regulations associated with the geographic location of the data (block 530). For example, the client device may request geo-location information associated with data from the geo-location authority referenced by the geo-location header, the geo-location information indicating a validity state for the data based at least in part on one or more regional regulations associated with the geographic location of the data, as described above.

As further shown in FIG. 5, process 500 includes displaying an indication of the validity state for the data (block 540). For example, the client device may display an indication of the validity state for the data, as described above.

Process 500 may include additional aspects, such as any single aspect or any combination of aspects described below and/or in connection with one or more other processes described elsewhere herein.

In a first aspect, the geo-location header includes a reference to the geo-location authority.

In a second aspect, requesting the access to the cloud-based application includes requesting the access via a web browser, and requesting the geo-location information associated with the data includes requesting the geo-location information associated with the data via a plug-in application in the web browser.

In a third aspect, the plugin application is configured to recover information from the geo-location header.

In a fourth aspect, requesting the geo-location information associated with the data includes requesting the geo-location information via at least one of a programming language library, a command-line tool, or HTTP protocol.

In a fifth aspect, the cloud-based application is a software-as-a-service (SaaS) application.

In a sixth aspect, process 500 includes receiving, by the client device, user input that specifies one or more acceptable geographical locations for the data used by the cloud-based application, and deriving the validity state based at least in part on comparing the geographic location indicated by the geo-location information to the one or more acceptable geographical locations.

In a seventh aspect, process 500 includes retrieving, by the client device and from the geo-location authority, a list of one or more acceptable geographical locations for the data used by the cloud-based application, and deriving the validity state based at least in part on comparing the geographic location indicated by the geo-location information to the list of one or more acceptable geographical locations.

In an eighth aspect, the indication is an icon.

In a ninth aspect, process 500 includes receiving user input that indicates to display additional information, relative to the indication of the valid state, about the geographic location of the data, displaying, based at least in part on receiving the user input, at least one of a first country where the data is stored, a second country where the data is processed, or a server location of a server that processes the data.

In a tenth aspect, the geographic location is a first geographic location, and process 500 includes receiving a notification of a location change for the data from the first geographic location to a second geographic location, and updating the indication of the validity state for the data based at least in part on the second geographic location.

In an eleventh aspect, the notification of the location change includes an updated geo-location code for the data, the updated geo-location code indicating the second geographic location.

In a twelfth aspect, the notification of the location change includes a revised validity state for the data, the revised validity state being based at least in part on the regional regulations associated with the second geographic location.

In a thirteenth aspect, the indication displayed by the client device indicates compliance with regional regulations based at least in part on the geo-location information indicating that the geographical location of the data is valid.

In a fourteenth aspect, the indication displayed by the client device indicates non-compliance with regional regulations based at least in part on the geo-location information indicating that the geographical location of the data is not valid.

In a fifteenth aspect, process 500 includes receiving, from the geo-location authority, a response message that indicates the geo-location information.

In a sixteenth aspect, the geo-location information indicates one or more geo-location codes.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

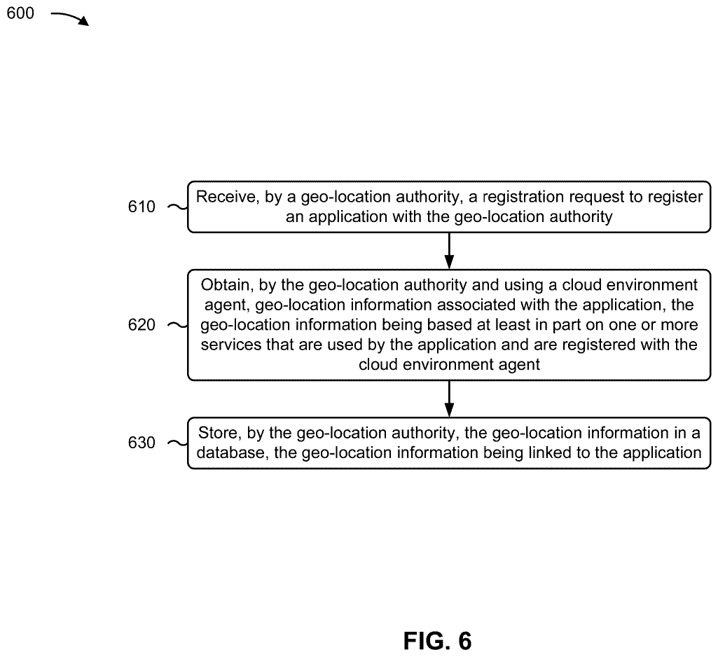

FIG. 6 is a flowchart of an example process 600 associated with validating geo-location for data access. One or more process blocks of FIG. 6 are performed by a geo-location authority device (e.g., a geo-location authority device 202) and/or by another device or a group of devices separate from or including the geo-location authority, such as a client device (e.g., a client device 302) a developer device (e.g., a developer device 206), a cloud environment (e.g., the cloud environment 208 and/or the cloud environment 306) and/or an administrator device (e.g., administrator device 204. Additionally, or alternatively, one or more process blocks of FIG. 6 may be performed by one or more components of computer 102, such as processor set 114, memory 118, persistent storage 120, and/or peripheral device set 122.

As shown in FIG. 6, process 600 includes receiving a registration request to register an application with the geo-location authority (block 610). For example, the geo-location authority may receive a registration request to register an application with the geo-location authority, as described above.

As further shown in FIG. 6, process 600 includes obtaining, using a cloud environment agent, geo-location information associated with the application, the geo-location information being based at least in part on one or more services that are used by the application and are registered with the cloud environment agent (block 620). For example, the geo-location authority may obtain, using a cloud environment agent, geo-location information associated with the application, the geo-location information being based at least in part on one or more services that are used by the application and are registered with the cloud environment agent, as described above.

As further shown in FIG. 6, process 600 includes storing the geo-location information in a database, the geo-location information being linked to the application (block 630). For example, the geo-location authority may store the geo-location information in a database, the geo-location information being linked to the application, as described above.

Process 600 may include additional aspects, such as any single aspect or any combination of aspects described below and/or in connection with one or more other processes described elsewhere herein.

In a first aspect, the registration request includes at least one of an identifier of the application, or a description of the application.

In a second aspect, process 600 includes receiving a request for the geo-location information associated with the application, retrieving the geo-location information from the database, and sending the geo-location information.

In a third aspect, the cloud environment agent includes a Kubernetes operator.

In a fourth aspect, process 600 includes obtaining, using the cloud environment agent, a geo-location code for the application, the geo-location code being associated with a geographical location of data that is used by the application.

In a fifth aspect, obtaining the geo-location code includes obtaining the geo-location code based at least in part on at least one of a set of coordinates associated with the geographical location of the data, a geolocation identifier associated with the geographical location of the data, a subscriber identity module device, or a country code associated with the geographical location of the data.

In a sixth aspect, obtaining the geo-location information associated with the application includes receiving one or more service registration messages that register the one or more services with the geo-location authority, each service registration message of the one or more service registration messages including at least a portion of the geo-location information.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM) or Flash memory, static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
requesting, by a client device, access to a cloud-based application that uses data that is stored in a geographic location;
receiving, by the client device, a response from the cloud-based application, the response including a geo-location header that includes a reference to a geo-location authority;
requesting, by the client device, geo-location information associated with data from the geo-location authority referenced by the geo-location header, the geo-location information indicating a validity state for the data based at least in part on regional regulations associated with a location of the client device; and
displaying an indication of the validity state for the data using the geo-location information.

2. The method of claim 1, wherein the geo-location header includes a reference to the geo-location authority.

3. The method of claim 1, wherein requesting the access to the cloud-based application comprises:
requesting the access via a web browser, and
wherein requesting the geo-location information associated with the data comprises:
requesting the geo-location information associated with the data via a plug-in application in the web browser.

4. The method of claim 3, wherein the plug-in application is configured to recover information from the geo-location header.

5. The method of claim 1, wherein requesting the geo-location information associated with the data comprises:
requesting the geo-location information via at least one of:
a programming language library;
a command-line tool; or
or a hypertext transfer protocol.

6. The method of claim 1, further comprising:
receiving, by the client device, user input that specifies one or more acceptable geographical locations for the data used by the cloud-based application; and
deriving the validity state based at least in part on comparing the geographic location indicated by the geo-location information to the one or more acceptable geographical locations.

7. The method of claim 1, further comprising:
retrieving, by the client device and from the geo-location authority, a list of one or more acceptable geographical locations for the data used by the cloud-based application; and
deriving the validity state based at least in part on comparing the geographic location indicated by the geo-location information to the list of the one or more acceptable geographical locations.

8. The method of claim 1, further comprising:
receiving user input that indicates to display additional information, relative to the indication of the validity state, about the geographic location of the data; and
displaying, based at least in part on receiving the user input, at least one of:
a first country where the data is stored,
a second country where the data is processed, or
a server location of a server that processes the data.

9. The method of claim 1, wherein the geographic location is a first geographic location, and
wherein the method further comprises:
receiving, by the client device, a notification of a location change for the data from the first geographic location to a second geographic location; and
updating, by the client device, the indication of the validity state for the data based at least in part on the second geographic location.

10. A method comprising:
receiving, by a geo-location authority, a registration request to register an application with the geo-location authority;
obtaining, by the geo-location authority and using a cloud environment agent, geo-location information associated with the application, the geo-location information being based at least in part on one or more services that are used by the application and are registered with the cloud environment agent; and
storing, by the geo-location authority, the geo-location information in a database, the geo-location information being linked to the application.

11. The method of claim 10, wherein obtaining the geo-location information associated with the application comprises:
receiving one or more service registration messages that register the one or more services with the geo-location authority, each service registration message of the one or more service registration messages including at least a portion of the geo-location information.

12. The method of claim 10, wherein the registration request comprises at least one of:
an identifier of the application, or
a description of the application.

13. The method of claim 10, further comprising:
receiving a request for the geo-location information associated with the application;
retrieving the geo-location information from the database; and
sending the geo-location information.

14. The method of claim 10, wherein the cloud environment agent comprises a Kubernetes operator.

15. The method of claim 10, further comprising:
obtaining, using the cloud environment agent, a geo-location code for the application, the geo-location code being associated with a geographical location of data that is used by the application.

16. The method of claim 15, wherein obtaining the geo-location code comprises:
obtaining the geo-location code based at least in part on at least one of:
a set of coordinates associated with the geographical location of the data,
a geolocation identifier associated with the geographical location of the data,
a subscriber identity module device, or
a country code associated with the geographical location of the data.

17. The method of claim 15, wherein the geo-location information stored in the database comprises the geo-location code.

18. A computer program product, comprising:
one or more computer-readable storage media; and
program instructions stored on the one or more computer-readable storage media to cause a processor set to perform operations comprising:
requesting access to a cloud-based application that uses data that is stored in a geographic location;
receiving a response from the cloud-based application, the response including a geo-location header that includes a reference to a geo-location authority;
requesting geo-location information associated with data from the geo-location authority referenced by the geo-location header, the geo-location information indicating a validity state for the data based at least in part on regional regulations associated with a location of a client device; and
displaying an indication of the validity state for the data.

19. The computer program product of claim 18, wherein the program instructions are further configured to cause the processor set to perform operations comprising:
retrieving, by the client device and from the geo-location authority, a list of one or more acceptable geographical locations for the data used by the cloud-based application; and
deriving the validity state based at least in part on comparing the geographic location indicated by the geo-location information to the list of the one or more acceptable geographical locations.

20. The computer program product of claim 19, wherein the program instructions to cause the processor to perform requesting the access to the cloud-based application are further configured to cause the processor set to perform operations comprising:
requesting the access via a web browser, and
wherein the program instructions to cause the processor to perform requesting the geo-location information are further configured to cause the processor set to perform operations comprising:
requesting the geo-location information associated with the data via a plug-in application in the web browser.
